(19) United States
(12) Patent Application Publication
(10) Pub. No.: US 2011/0217484 A1
(43) Pub. Date: Sep. 8, 2011

(54) METHOD FOR REPAIRING SEAL SEGMENTS OF ROTOR/STATOR SEALS OF A GAS TURBINE

(75) Inventors: Tim Lübcke, Hamburg (DE); Volker Tiedemann, Kayhude (DE)

(73) Assignee: LUFTHANSA TECHNIK AG, Hamburg (DE)

(21) Appl. No.: 13/040,093

(22) Filed: Mar. 3, 2011

(30) Foreign Application Priority Data
Mar. 8, 2010 (DE) 102010010595.3

(51) Int. Cl. B05D 3/00; B23K 31/02; H05H 1/24

(52) U.S. Cl. 427/569; 427/140; 228/119

(57) ABSTRACT

The subject of the invention is a method for repairing sealing surfaces of seal segments, arranged on the inner circumference of a turbine casing section, of a rotor/stator seal of a gas turbine. With the method according to the invention, first of all material is removed from the sealing surfaces of the seal segments with the exception of the base material of the seal segments, a metallic reinforcing coating with a material thickness of at least 1 mm is applied, and then a ceramic coating with a material thickness of 0.3 to 2 mm is applied to it.

The method refers to a method for repairing sealing surfaces of seal segments, arranged on the inner circumference of a turbine casing section, of a rotor/stator seal of a gas turbine.

In turbomachines, especially gas turbines such as jet engines of aircraft, leakage flows through gaps between interacting rotor and stator components, which move relative to each other, reduce the efficiency. In order to minimize these gap losses and therefore to keep the efficiency of the turbomachine high, it is necessary during running operation of the machine to minimize the gap between the customarily high-speed rotating rotor blades and the sealing surface of the casing, which sealing surface is part of the stator and encompasses the rotor. This is a problem since rotor blades elongate in the radial direction in the case of high load both as a result of thermal stress and as a result of centrifugal forces, whereas the casing as a rule experiences only slight thermal expansion and thereby enlargement of the casing circumference. The gap size is therefore variable during operation of the gas turbine.

In order to take into consideration these gap size changes, so-called abradable seals are known (U.S. Pat. No. 4,299,865). In this case, the blade tips of the rotor are produced from a hard material or provided with a hard coating and the abradable seal of the encompassing stator is of a comparatively soft design. In different operating states, cutting in by the blade tips into the stator seal can then occur and material removal of the abradable seal can take place without damage to the blades occurring.

Abradable seals may consist of ceramic or metallic materials or a combination thereof. They can also have a laminated structure consisting of metallic and ceramic materials.

The invention is based on the object of creating a method of the type referred to in the introduction which enables a simple and inexpensive application of an abradable seal when renewing or exchanging a rotor/stator seal in the course of maintenance or repair of a gas turbine. The method according to the invention has the following steps:
a) Removing material from the sealing surfaces of the seal segments with the exception of the base material of the seal segments,
b) Applying at least one metallic reinforcing coating with a material thickness of at least 1 mm,
c) Applying a ceramic coating with a material thickness of 0.3 to 2 mm.

First of all, some of the terms used within the scope of the invention are to be explained.

A gas turbine is a turbomachine in which the thermal energy of a hot gas flow, which is produced as a result of combustion of hydrocarbons or other fuels, is converted into mechanical energy. The invention is particularly applicable in the case of jet engines or turbo-prop engines of aircraft.

A rotor/stator seal seals components of the gas turbine, which operate in a rotational motion relative to each other, against one another, especially the blade tips of a rotor against the circumference of an enclosing turbine casing.

The term turbine casing section within the context of Claim 1 refers to that part of the turbine which has or supports the stator seal which encompasses the rotor. Within the scope of the invention, it can especially be a module of a jet engine, in which the stator seal is arranged.

Seal segments are arranged on the inner circumference of this turbine casing section. The term seal segments refers to removable or individually exchangeable parts which in each case line a small portion of the inner circumference of the turbine casing. A multiplicity of seal segments extend over the entire circumference of the turbine casing section and together form the stator seal.

The seal segments have sealing surfaces, these being those surfaces which face the rotor. According to the invention, a metallic reinforcing coating and a ceramic coating are applied to these sealing surfaces. The term ceramic coating within the scope of the invention refers to all the materials which have a portion of ceramic materials and are suitable for forming a so-called abradable seal (cut-in seal). As a rule, these ceramic coatings are based on materials such as ZrO₂, Al₂O₃ and/or other metal-, transitional metal-, or rare earth oxides or mixed oxides.

According to the invention, in the first step material is removed from the sealing surfaces of the seal segments with the exception of the base material. This means that any abradable seals (ceramic or metallic) are completely removed so that the base material of the seal segment is provided as a substrate for the metallic reinforcing coating which is to be applied in the next step.

The metallic coating which is applied in step b) is referred to as a reinforcing coating in order to signify that this increases the dimensions of the seal segment in the radial direction. In this case, it is not a case of a soft metallic abradable coating but a reinforcement of the base material of the seal segment, preferably with a material which is similar to or of the same type as the base material.

It is the essence of the invention, when carrying out the repair, to replace an abradable seal, which is comparatively thick in the radial direction, by an appreciably thinner seal and, for this purpose, after removing the abradable seal originally attached (and as a rule completely or partially worn) on the component, to first of all reinforce the base material of the seal segment in the radial direction in order to thus create the base for applying a thinner ceramic abradable seal.

The metallic reinforcing coating preferably has a material which is of the same type as the base material of the seal segment. Of the same type means that it is a material and/or a metal which is identical and/or similar in properties, or is a corresponding alloy.

The metallic reinforcing coating can preferably be applied by means of a process selected from the group consisting of welding, soldering and solder-diffusion using a presintered solder preform. These techniques are basically familiar to the person skilled in the art and by way of example of the repair of turbine vanes are described for example in Materials Science and Technology, September 1985, Volume 1, 719. Under suitable welding methods, tungsten inert gas welding and also electron beam welding may be exemplarily named.

Suitable soldering processes are described for example in U.S. Pat. No. 7,363,707 B2.

Especially preferred within the scope of the invention is the application of the metallic reinforcing coating by means of solder-diffusion using a presintered solder preform. This technique is described for example in U.S. Pat. No. 4,614,296. For producing a solder preform, metal powder of the base material (base powder) is pressed with a low-melting metal powder (solder powder). The solder powder partially melts during the presintering so that a solid substance (solder preform) results. The base powder is preferably powder of a superalloy, for example the nickel-based superalloy Rene 80. As solder powder, nickel-based solders with an element which low-ers the melting point and has a high diffusion rate in the base material (the superalloy), for example boron, are preferably used. When carrying out the diffusion soldering, the solder preform is deposited upon the seal segment and heated to a soldering temperature which allows the melting of the solder powder. The melting temperature of the solder powder lies below the solidus temperature of the superalloy so that this is not melted during the diffusion soldering. In the course of the diffusion soldering process, the initially liquefied solder solidifies isothermally on account of the diffusion of the boron, which lowers the melting point, into the base material. The solder preform preferably has at least 40% by weight, preferably 50 to 85% by weight, more preferably 60 to 80% by weight of a base powder, of the same type as the base material of the seal segment, and a solder powder.

The metallic reinforcing coating which is applied according to the invention can preferably have a material thickness of 1 to 4 mm, more preferably 1 to 3.5 mm, more preferably 1.5 to 3 mm, more preferably 2 to 3 mm. The said upper and lower limits can be optionally combined to form ranges according to the invention.

It is preferred within the scope of the invention that before applying the ceramic coating a bond coat is applied to the substrate of the seal segments. The thickness of the bond coat is preferably 0.1 mm or less. In the case of the bond coat, it is preferably a MCrAlY coating in which M is preferably a metal selected from the group consisting of nickel, cobalt, iron or combinations of these. Other elements such as hafnium or silicon can be added as a so-called reactive element addition in order to increase the resistance to oxidation and service life of the bond coat. The bond coat is preferably applied by means of plasma spraying. If necessary, vacuum plasma spraying (low vacuum plasma spray, LVPS) can be used, but also atmospheric plasma spraying. A suitable material for the bond coat is for example a fine-grained powder on a CoNiCrAlY base, such as Amdry 995, obtained from Sulzer Metco.

The application of the ceramic coating is carried out according to the invention preferably by means of atmospheric plasma spraying (APS). During plasma spraying, a plasma jet is used, the thermal energy of which is created as a result of the recombination of a previously produced gas plasma. In the plasma jet, the material to be applied is fed as powder. In the case of atmospheric plasma spraying, the removal of material is carried out in normal environmental atmosphere. The use of atmospheric plasma spraying as a method for applying the ceramic coating has the particular advantage that the turbine casing sections, which as a rule are quite large, do not have to be transferred into a controlled atmosphere such as a vacuum chamber. The quality of the ceramic coating which can be achieved with atmospheric plasma spraying is readily adequate for the purposes according to the invention.

The turbine casing section, according to the invention, for example can be a so-called high pressure turbine (HPT) shroud support of a jet engine. The possibly good sealing effect or the achieving of a small sealing gap according to the invention can makes itself felt, especially in the high-pressure turbine, in improved efficiency and in fuel economy as a result. The ceramic coating which is applied according to the invention preferably has a porosity of 10 to 40% by volume, more preferably 20 to 30% by volume. Such porosity contributes to designing the ceramic coating sufficiently soft and to provide its so-called abradable properties.

If the blade tip of the rotor makes contact with such a ceramic coating, the material pairing or rubbing pairing is to be designed in such a way that the sealing surface of the ceramic coating is exclusively or predominantly removed and no wear, or only a little wear, occurs on the blade tip.

For achieving the porosity, it is preferred that the applied ceramic material at the time of application contains a portion of a thermally removable material. In this case, it can especially be a polymer such as a polyester. Thermally removable means that the material, when supplying thermal energy, escapes from the ceramic coating largely or completely without residue and in so doing leaves behind cavities in the form of pores. The removal can be carried out by means of evaporation, sublimation or thermal decomposition or combustion, the gaseous products of decomposition escaping. An erosion-resistant ceramic intermediate coating can optionally be applied to the bond coat using a ceramic powder such as Praxair 1484. This is preferably carried out by means of atmospheric plasma spraying, which results in a coating thickness of 100 to 300 μm.

The ceramic material of the ceramic coating is based for example on ZrO₂ (zirconium dioxide) and can be doped with rare earth metal oxides such as Y₂O₃ or others. Suitable sprayable ceramic powders can be based for example on YSZ (yttria-stabilized zirconia) and contain for example polyester for producing the desired porosity. A suitable powder is obtainable from Sulzer Metco, for example, under the designation Metco 2460 NS.

The thickness of the applied ceramic coating can preferably lie with the range of 0.2 to 2 mm, more preferably 0.5 to 1.5 mm. Such a comparatively thin ceramic abradable coating has no tendency or little tendency to break away in comparison to a thick ceramic abradable coating (for example 4 mm thick) which can be replaced by the method according to the invention.

An exemplary embodiment of the invention is described in the following text with reference to the drawings. In the drawings:

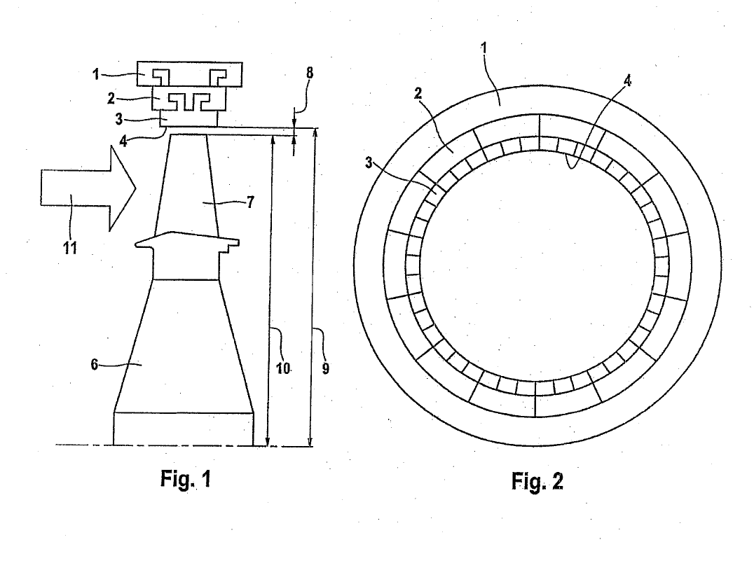

FIG. 1: shows a cross section through a gas turbine section;

FIG. 2: shows a plan view of a turbine casing;

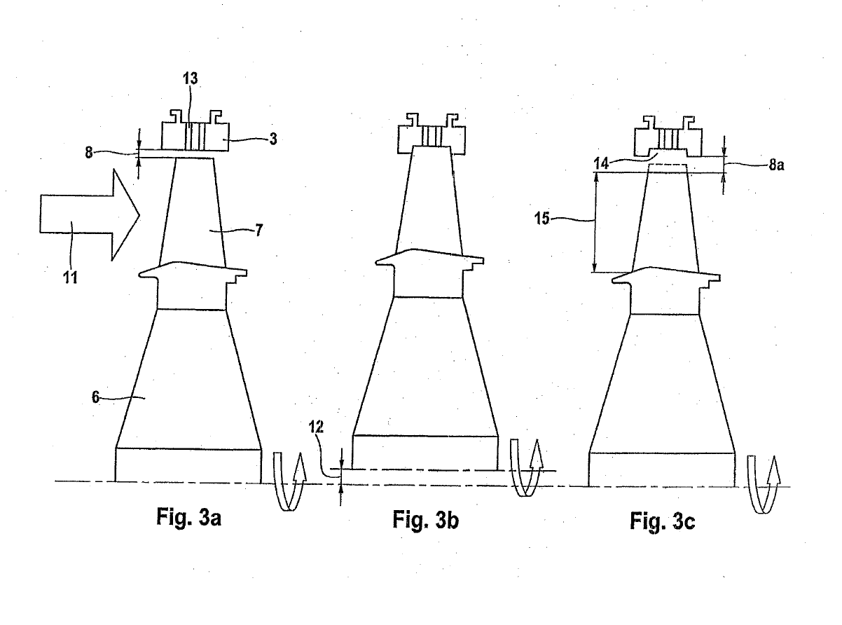

FIG. 3: shows the interaction of turbine blade and sealing surface during operation.

FIG. 2 shows in plan view a turbine casing 1, on the inner circumference of which holding segments 2 for the seal segments 3 are arranged. The seal segments 3, which butt against each other around the circumference of the turbine casing 1, have sealing surfaces 4 on their radially inwardly pointing circumferential surfaces 4.

In FIG. 1, reference number 5 schematically shows the rotational symmetry axis of the gas turbine. A multiplicity of turbine rotor blades 7 (rotor blades or rotor vanes) are arranged on the rotor disk 6, distributed around the circumference. The radially outwardly pointing tips of the turbine blades 7 seal against the sealing surfaces 4 of the seal segments 3 and with these include a sealing gap 8 which is calculated from the difference of the stator radius 9 and the rotor radius 10. The arrow 11 refers to the direction of the gas flow which flows through the gas turbine.

FIG. 3a shows the initial state which is also shown in FIG. 1. The seal segment 3 in this embodiment has a ceramic sealing surface.

During operation of the engine, on account of thermal expansions and/or of rotor eccentricity, which is schematically shown by 12 in FIG. 3b, cutting in of the turbine blade 7 into the sealing surface of the seal segment 3 can occur. As a result of the cutting in, a cut-in notch 14, which is schematically shown in FIG. 3c, is created in the seal segment 3 and the blade length 15 is reduced as a result of material removal at the tip of the turbine blade 7. An enlarged sealing gap 8a ensues and the efficiency of the engine reduces.

For implementing a repair method according to the invention, first of all the existing and completely or partially worn abradable seal (abradable coating) is completely removed from the seal segment 3. In the exemplary embodiment, it is a porous ceramic coating which is about 4 mm thick in the original new state. This, or its residue, is removed by means of a high-pressure water jet. If necessary, remaining residue of the abradable seal can be chemically and/or mechanically (for example by grinding) removed. The removal is therefore carried out with the exception of the base material of the seal segment 3, which is a nickel-based superalloy.

A check of the seal segment is then carried out, especially a check for cracks by means of penetrating fluorescent dye solution. If cracks are indicated, these can be remedied by means of surface welding, for example, especially tungsten inert gas surface welding.

The sealing surfaces of the seal segment 3, which are removed with the exception of the base material, are prepared by means of grinding for applying the metallic reinforcing coating. A solder-preform of the desired shape and thickness is attached to the sealing surface of the seal segment 3 by means of resistance spot welding. The applied solder-preform contains 70% by weight of a nickel-based powder (Rene 80) of the same type as the nickel-based superalloy of the seal segment 3 and 30% by weight of nickel-based solder Praxair NI-173 with boron as a melting point lowering agent.

The seal segment 3 with the attached solder-preform is taken into a vacuum oven and at a pressure of 10⁻⁴ mbar is heated to the soldering temperature of 1210° C. and held at this temperature for 15 min. The temperature is then lowered to the diffusion temperature of 1100° C. and held at this temperature for 120 min.

After cooling, a visual check and an adjustment of the final shape are carried out. This adjustment may include for example grinding or else hot forming of the seal segments in a hot form press. A check for cracks can again follow by means of fluorescent dye.

For preparation of the plasma coating (applying the ceramic coating), a so-called activation radiation is carried out. For this purpose, Al₂O₃ blasting medium of grain mesh 36 is used.

In the next step, a bond coat is applied. For this purpose, a fine-grained powder on MCrAlY-based Amdry 995 is applied by means of vacuum plasma spraying. The coating thickness of this bond coat lies between 100 and 300 μm. An erosion-resistant ceramic intermediate coating can be optionally applied to the bond coat using a ceramic powder such as Praxair 1484. This is preferably carried out by means of atmospheric plasma spraying, which results in a coating thickness of 100 to 300 μm.

In the next step, the actual ceramic abradable coating with the desired material thickness of between 0.3 and 2 mm (1.2 to 1.5 mm in the exemplary embodiment) is applied. As coating material, Metco 2460 NS is used.

The newly applied sealing surface is machined, especially ground, if necessary.

By means of the method according to the invention, a comparatively thick ceramic abradable coating (4 mm) has therefore been replaced by a thin ceramic abradable coating which is applied to a seal segment which is reinforced in the substance of the base material by means of diffusion soldering.

1. Method for repairing sealing surfaces of seal segments, arranged on the inner circumference of a turbine casing section, of a rotor/stator seal of a gas turbine, with the steps:
a) Removing material from the sealing surfaces (4) of the seal segments (3) with the exception of the base material of the seal segments,
b) Applying at least one metallic reinforcing coating with a material thickness of at least 1 mm,
c) Applying a ceramic coating with a material thickness of 0.3 to 2 mm.

2. Method according to claim 1, characterized in that the metallic reinforcing coating has a material of the same type as the base material of the seal segment.

3. Method according to claim 1, characterized in that the metallic reinforcing coating is applied by means of a process selected from the group consisting of welding, soldering and solder-diffusion using a presintered solder-preform.

4. Method according to claim 3, characterized in that the solder preform has at least 40% by weight, preferably 50 to 85% by weight, more preferably 60 to 80% by weight of a base powder of the same type as the base material of the seal segment, and a solder powder.

5. Method according to claim 1, characterized in that the metallic reinforcing coating has a material thickness of 1 to 4 mm, preferably 1 to 3.5 mm, more preferably 1.5 to 3 mm, more preferably 2 to 3 mm.

6. Method according to claim 1, characterized in that a bond coat (18) is applied before applying the ceramic coating.

7. Method according to claim 6, characterized in that the bond coat (18) has a material based on MCrAlY.

8. Method according to claim 6, characterized in that the thickness of the bond coat (18) is 0.1 mm or less.

9. Method according to claim 1, characterized in that the application of the ceramic coating (21) is carried out by means of atmospheric plasma spraying (APS).

10. Method according to claim 1, characterized in that the ceramic coating (21) has a porosity of 10 to 40% by volume, preferably 20 to 30% by volume.

11. Method according to claim 10, characterized in that the porosity is effected by a portion of a thermally removable material in the applied ceramic material.

12. Method according to claim 11, characterized in that the thermally removable material is a polymer, preferably a polyester.

13. Method according to claim 1, characterized in that the ceramic material of the ceramic coating contains ZrO₂.

14. Method according to claim 1, characterized in that the thickness of the applied ceramic coating (21) is 0.2 to 2 mm, preferably 0.5 to 1.5 mm.
